(19) United States
(12) Patent Application Publication
(10) Pub. No.: US 2021/0333657 A1
(43) Pub. Date: Oct. 28, 2021

(54) DISPLAY DEVICE, METHOD FOR MANUFACTURING THE DISPLAY DEVICE, AND METHOD FOR CONTROLLING CONTRAST

(71) Applicants: HEFEI BOE DISPLAY TECHNOLOGY CO., LTD., Anhui (CN); BOE TECHNOLOGY GROUP CO., LTD., Beijing (CN)

(72) Inventors: Qingwen XU, Beijing (CN); Dasheng HUI, Beijing (CN)

(21) Appl. No.: 16/340,456

(22) PCT Filed: Nov. 28, 2018
(86) PCT No.: PCT/CN2018/117778

§ 371 Date: Apr. 9, 2019

(30) Foreign Application Priority Data
Mar. 26, 2018 (CN) 201810251898.8

(51) Int. Cl. G02F 1/1343; G02F 1/1335; G09G 3/36

(52) U.S. Cl. CPC G02F 1/134363; G09G 2320/066; G09G 3/3607; G02F 1/133531

(57) ABSTRACT

A method for manufacturing a display device, and a method for controlling a contrast in such display devices. The display device includes: a liquid crystal cell including a first substrate and a second substrate disposed opposite to each other; and a light valve controller located at a side of the first substrate facing away from the second substrate; the light valve controller including an upper substrate and a lower substrate disposed opposite to each other, and liquid crystal molecules located between the upper substrate and the lower substrate. The liquid crystal cell includes a plurality of display sub- pixels arranged in an array; the light valve controller includes a plurality of control sub-pixels arranged in an array; the display sub-pixels and the control sub-pixels are in one-to-one correspondence.

### RELATED APPLICATIONS

The present application is the U.S. national phase entry of the international application PCT/CN2018/117778, with an international filing date of Nov. 28, 2018, which claims the benefit of Chinese Patent Application No. 201810251898.8, filed on Mar. 26, 2018, the entire disclosures of which are incorporated herein by reference.

### TECHNICAL FIELD

The present disclosure relates to the field of display technology, and particularly to a display device, a method for manufacturing the display device, and a method for controlling a contrast.

### BACKGROUND

The liquid crystal panel of the advanced super dimension switch type (ADS) display mode forms a multi-dimensional electric field by an electric field generated by edges of some electrodes in the same plane and an electric field generated between an electrode layer and a plate electrode layer, so that all the liquid crystal molecules between the electrodes and directly above the electrodes are rotated.

### SUMMARY

In an exemplary embodiment, a display device is provided. The display device includes: a liquid crystal cell including a first substrate and a second substrate disposed opposite to each other; and a light valve controller located at a side of the first substrate facing away from the second substrate; the light valve controller including an upper substrate and a lower substrate disposed opposite to each other, and liquid crystal molecules located between the upper substrate and the lower substrate. The liquid crystal cell includes a plurality of display sub-pixels arranged in an array; the light valve controller includes a plurality of control sub-pixels arranged in an array; the display sub-pixels and the control sub-pixels are in one-to-one correspondence.

In some exemplary embodiments, the first substrate of the liquid crystal cell is provided with a plurality of first pixel electrodes for controlling the display sub-pixels; the lower substrate of the light valve controller is provided with a plurality of second pixel electrodes for controlling the control sub-pixels; an orthographic projection of a first pixel electrode on the lower substrate overlaps with an orthographic projection of a second pixel electrode on the lower substrate.

In some exemplary embodiments, the second substrate is provided with a first common electrode; the first common electrode is located at a side of the second substrate facing the first substrate; the upper substrate is provided with a second common electrode; an orthographic projection of the first common electrode on the lower substrate overlaps with an orthographic projection of the second common electrode on the lower substrate.

In some exemplary embodiments, the lower substrate is located on a side of the upper substrate facing away from the liquid crystal cell; the lower substrate is provided with a first polarizer; one of the upper substrate and the first substrate is provided with a second polarizer; the second substrate is provided with a third polarizer.

In some exemplary embodiments, a polarization direction of the third polarizer is same to a polarization direction of the first polarizer.

In some exemplary embodiments, the display device further includes: a backlight module located at a side of the light valve controller facing away from the liquid crystal cell.

In some exemplary embodiments, the display device further includes: a control circuit connected to the first pixel electrodes and the second pixel electrodes respectively; the control circuit being configured to input a same signal to a first pixel electrode and a corresponding second pixel electrode.

In some exemplary embodiments, a method for manufacturing a display device is provided. In certain exemplary embodiments the method includes: providing a liquid crystal cell, the liquid crystal cell including a first substrate and a second substrate disposed opposite to each other; and arranging a light valve controller at a side of the first substrate facing away from the second substrate; the light valve controller including an upper substrate and a lower substrate disposed opposite to each other, and liquid crystal molecules located between the upper substrate and the lower substrate. The liquid crystal cell includes a plurality of display sub-pixels arranged in an array; the light valve controller includes a plurality of control sub-pixels arranged in an array; the display sub-pixels and the control sub-pixels are in one-to-one correspondence.

In some exemplary embodiments, the second substrate of the liquid crystal cell is provided with a first common electrode, and the first substrate is provided with a plurality of first pixel electrodes; the step of arranging the light valve controller at the side of the first substrate facing away from the second substrate includes: arranging a second common electrode on the upper substrate, and arranging a plurality of second pixel electrodes and a polarizer on the lower substrate; disposing the upper substrate and the lower substrate oppositely, and arranging the liquid crystal molecules between the upper substrate and the lower substrate; an orthographic projection of the first common electrode on the lower substrate overlaps with an orthographic projection of the second common electrode on the lower substrate; an orthographic projection of a first pixel electrode on the lower substrate overlaps with an orthographic projection of a second pixel electrode on the lower substrate.

In another exemplary embodiment, a method for controlling a contrast of a display device is provided. In certain exemplary embodiments, the display device includes: a liquid crystal cell including a first substrate and a second substrate disposed opposite to each other; and a light valve controller located at a side of the first substrate facing away from the second substrate; the light valve controller including an upper substrate and a lower substrate disposed opposite to each other, and liquid crystal molecules located between the upper substrate and the lower substrate; the liquid crystal cell includes a plurality of display sub-pixels arranged in an array; the light valve controller includes a plurality of control sub-pixels arranged in an array; the display sub-pixels and the control sub-pixels are in one-to-one correspondence; the method includes: controlling a display sub-pixel and a corresponding control sub-pixel by applying a same gray scale.

In some exemplary embodiments, the first substrate is provided with a plurality of first pixel electrodes; the lower substrate is provided with a plurality of second pixel electrodes; the second substrate is provided with a first common electrode; the upper substrate is provided with a second common electrode; the method for controlling a contrast of the display device further includes: applying a same common voltage signal on the first common electrode and the second common electrode; and inputting a same signal to a first pixel electrode and a corresponding second pixel electrode by a control circuit.

### BRIEF DESCRIPTION OF THE DRAWINGS

In order to more clearly illustrate the technical solutions in embodiments of the disclosure or in the prior art, the appended drawings needed to be used in the description of exemplary embodiments or the prior art will be introduced briefly in the following. Obviously, the drawings in the following description are only some embodiments of the disclosure, and for those of ordinary skill in the art, other embodiments may be obtained according to these drawings under the premise of not paying out creative work.

FIG. 1 is a structural schematic diagram of a display device according to an exemplary embodiment;

FIG. 2 is a structural schematic diagram of a display device according to another exemplary embodiment;

FIG. 3 is a structural schematic diagram of a display device according to an exemplary embodiment;

FIG. 4 is a working principle diagram of a display device according to an exemplary embodiment;

FIG. 5 is a schematic diagram showing a display effect of a display device according to an exemplary embodiment; and

FIG. 6 is a flow chart of a method for manufacturing a display device according to an exemplary embodiment.

### DETAILED DESCRIPTION OF THE DISCLOSURE

In the following, the technical solutions in exemplary embodiments will be described clearly and completely in connection with the drawings disclosed herein. Obviously, the described exemplary embodiments are only part of the embodiments of the disclosure, and not all of the embodiments. Based on the exemplary embodiments disclosed herein, all other embodiments obtained by those of ordinary skill in the art.

The present disclosure is based on the following facts and technical problems, which have been discovered and considered by the inventors. Liquid crystal displays have a problem of relatively low contrast. For example, the contrast of a liquid crystal display in an ADS display mode can only be maintained at a low level of around 1200. The inventors have found that the current method for improving the contrast of a liquid crystal display in an ADS display mode only focuses on improving the materials of polarizers and liquid crystals, etc., and there is no significant improvement to the contrast. Further, the inventors have found that the method for improving the contrast of the ADS mode liquid crystal display by reducing the light transmittance at the position of the display panel with the smallest brightness cannot increase the light transmittance at the position of the display panel with the largest brightness. Therefore, the above method has limited improvement on the contrast. In summary, the contrast of the liquid crystal display is relatively low, which seriously affects the display effect of the display device, thereby affecting the user's viewing experience.

The described exemplary embodiments are intended to alleviate or solve at least one of the above mentioned problems at least to some extent.

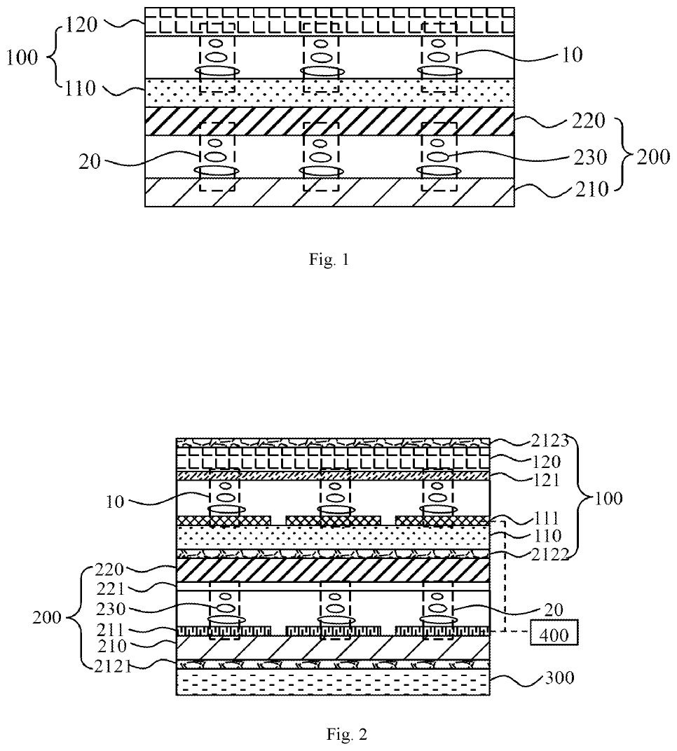

In an exemplary embodiment, a display device is provided. In certain exemplary embodiments, as shown in FIG. 1, the display device includes a liquid crystal cell 100 and a light valve controller 200. The liquid crystal cell 100 includes a first substrate 110 (e.g., an array substrate) and a second substrate 120 (e.g., a color film substrate) disposed opposite to each other. The light valve controller 200 is located at a side of the first substrate 110 facing away from the second substrate 120. The light valve controller 200 includes an upper substrate 220 and a lower substrate 210 disposed opposite to each other, and liquid crystal molecules 230 located between the upper substrate 220 and the lower substrate 210. In some exemplary embodiments, the liquid crystal cell 100 includes a plurality of display sub-pixels 10 arranged in an array (as indicated by the dashed boxes 10 in FIG. 1); the light valve controller 200 includes a plurality of control sub-pixels 20 arranged in an array (as indicated by the dashed boxes 20 in FIG. 1); the display sub-pixels 10 and the control sub-pixels 20 are in one-to-one correspondence. In this way, the display device has a high contrast, which significantly improves the display effect of the display device and the user's viewing experience.

In an exemplary embodiment, as an example, the first substrate 110 is an array substrate, and the second substrate 120 is a color film substrate. Those of ordinary skill in the art will understand that the first substrate 110 can also be a color film substrate, and the second substrate 120 can also be an array substrate. It will be understood by those of ordinary skill in the art that the liquid crystal cell 100 may further include liquid crystal molecules disposed between the array substrate 110 and the color film substrate 120 in order to realize the display function of the display device.

In some exemplary embodiments, the display sub-pixel 10 and the control sub-pixel 20 are in one-to-one correspondence. The orthographic projection of each display sub-pixel 10 on the lower substrate overlaps with the orthographic projection of the corresponding control sub-pixel 20 on the lower substrate. The orthographic projection of each control sub-pixel 20 on the array substrate overlaps with the orthographic projection of the corresponding display sub-pixel 10 on the array substrate.

To facilitate the understanding, a display device according to an exemplary embodiment will be briefly described below.

As mentioned herein, the liquid crystal display of the current ADS display mode has a poor contrast, which affects the user's viewing experience. At present, the method for improving the contrast of the liquid crystal display of the ADS display mode is mainly in the improvement of the materials, and the contrast is not significantly improved.

According to an exemplary embodiment, a light valve controller is disposed between the liquid crystal cell and the backlight module. The same circuit is used to control the light valve controller and the liquid crystal cell. Before the light enters the liquid crystal cell, the amount of light from the backlight and incident on the liquid crystal cell is adjusted in advance by using the light valve controller, so that the brightness of the backlight received at different positions of the liquid crystal cell is different. In this way, the area corresponding to a portion of the display image with a high brightness can receive a high brightness, and the area corresponding to a portion of the display image with a low brightness can receive a low brightness, thereby significantly improving the contrast of the display device.

For example, in theory, the contrast of the display device according to an exemplary embodiment can achieve a square of a contrast that can be achieved by using only a single liquid crystal cell.

Specifically, as described above, the display sub-pixels and the control sub-pixels are arranged in one-to-one correspondence, and the gray scale of the light emitted from the backlight module is firstly adjusted by the control sub-pixel in the light valve controller, therefore light beams incident on the different portions of the liquid crystal cell may have different gray scales. For example, the deflection of the liquid crystal molecules in the light valve controller at the position corresponding to the brightest region of the display image can be adjusted. Thus the brightness of the backlight may not be changed, then the brightness of the backlight is adjusted and emitted from the light valve controller, and is incident on the liquid crystal cell. In this way, through the adjustment of the liquid crystal molecules in the light valve controller, the light emitted from the position of the light valve controller corresponding to the darkest area in the display image has the darkest gray scale. After the light beams with different gray scales enter the liquid crystal cell, the light beams are adjusted by the display sub-pixels in the liquid crystal cell, so that the gray scale of the area with the highest brightness in the display image has the brightest gray scale of the backlight module, and the gray scale of the area with the lowest brightness in the display image has the darkest gray scale after being adjusted by the light valve controller. Therefore, the contrast of the display device can be significantly improved while ensuring the brightness of the display device. Compared to the adjustment of gray scale in the related art, the display device according to an exemplary embodiment is adjusted twice by the deflection of liquid crystal, i.e., the deflection of liquid crystal molecules in the control sub-pixels and the deflection of liquid crystal molecules in the display sub-pixels. However, the related art only uses the deflection of the liquid crystal molecules in the display sub-pixel. Therefore, according to an exemplary embodiment, the gray scale difference between the maximum brightness and the minimum brightness in the display image of the display device is larger, which may provide a high contrast.

The respective structures of the display device will be described in detail below in accordance with specific exemplary embodiments.

In some exemplary embodiments, referring to FIG. 2, the first substrate 110 (e.g., an array substrate) of the liquid crystal cell 100 is provided with a plurality of first pixel electrodes 111 for controlling the display sub-pixels 10; the lower substrate 210 of the light valve controller 200 is provided with a plurality of second pixel electrodes 211 for controlling the control sub-pixels 20; an orthographic projection of a first pixel electrode 111 on the lower substrate 210 overlaps with an orthographic projection of a second pixel electrode 211 on the lower substrate 210.

According to the display device provided by an exemplary embodiment, before the light enters the liquid crystal cell, the brightness of the backlight incident on the liquid crystal cell is adjusted in advance by using the light valve controller, so that the brightness of the backlight received at different positions of the liquid crystal cell is different. In this way, the area with a high brightness in the display image can receive light with a high brightness, and the area with a low brightness in the display image can receive light with a low brightness, so as to significantly improve the contrast of the display device.

Alternatively, the first pixel electrode 111 and the second pixel electrode 211 control the liquid crystal molecules in the display sub-pixel 10 and the liquid crystal molecules in the corresponding control sub-pixel 20 to have the same deflection degree to achieve the same gray scale. For example, the orthographic projection of the first pixel electrode 111 on the lower substrate 210 overlaps with the orthographic projection of the second pixel electrode 211 on the lower substrate 210 (that is, the electrode distribution on the array substrate is exactly the same as the electrode distribution on the lower substrate). By applying the same voltage signal to the two substrates, the same deflection of the liquid crystal molecules in the control sub-pixel and the corresponding display sub-pixel can be ensured. Therefore, on the one hand, the orthographic projections of the two sets of electrodes overlap with each other, and the transmittance of the entire display device can be high; on the other hand, the two substrates can be prepared by using the same production line; moreover, the two substrates can be connected to the same voltage signal, which also facilitates the simplification of the control circuit.

In some exemplary embodiments, the upper substrate 220 may be provided with a second common electrode 221. In this way, an electric field can be generated by the second common electrode and the second pixel electrode, and liquid crystal molecules between the upper substrate and the lower substrate can be rotated, thereby controlling the brightness of the control sub-pixel. The positional relationship of the second common electrode and the upper substrate is not particularly limited, and those skilled in the art can design the positional relationship according to specific conditions. For example, in some exemplary embodiments, the second common electrode 221 may be located on a side of the upper substrate 220 facing the lower substrate 210. Alternatively, according to some embodiments of the present disclosure, the second common electrode may also be located on a side of the upper substrate facing away from the lower substrate.

In some exemplary embodiments, the color film substrate 120 is provided with a first common electrode 121, and the first common electrode 121 is located on a side of the color film substrate 120 facing the array substrate 110. In this way, an electric field can be generated by the first common electrode and the first pixel electrode, and the liquid crystal molecules in the liquid crystal cell can be rotated, thereby adjusting the brightness of the display sub-pixel. In some exemplary embodiments, the upper substrate 220 is provided with a second common electrode 221, the color film substrate 120 is provided with a first common electrode 121, and the orthographic projection of the second common electrode 221 on the lower substrate 210 overlaps with the orthographic projection of the first common electrode 121 on the lower substrate 210. As described above, optionally, the first pixel electrode 111 and the second pixel electrode 211 control the liquid crystal molecules in the display sub-pixel 10 and the liquid crystal molecules in the corresponding control sub-pixel 20 to have the same deflection degree. Thus, on the one hand, the orthographic projections of the two sets of electrodes overlap with each other, and the transmittance of the entire display device is high; on the other hand, the two substrates can be prepared by using the same production line; moreover, the two substrates can be connected to the same voltage signal, which also facilitates the simplification of the control circuit.

In some exemplary embodiments, the display sub-pixel 10 is composed of the first common electrode 121, the first pixel electrode 111, and liquid crystal molecules disposed between the first common electrode 121 and the first pixel electrode 111; the control sub-pixel 20 is composed of the second common electrode 221, the second pixel electrode 211, and liquid crystal molecules 230 disposed between the second common electrode 221 and the second pixel electrode 211. As described above, according to an exemplary embodiment, the second common electrode 221 is disposed corresponding to the first common electrode 121, and the second pixel electrodes 211 are disposed one-to-one corresponding to the first pixel electrodes 111. In this way, the control sub-pixels can be arranged in one-to-one correspondence with the display sub-pixels. When the same electric signal is applied to the light valve controller and the liquid crystal cell, the brightnesses of the backlight received at different positions of the liquid crystal cell are different. Therefore, an area of the liquid crystal cell corresponding to a high brightness of the display image can receive a backlight with a high brightness, and an area of the liquid crystal cell corresponding to a low brightness of the display image can receive a backlight with a low brightness. Moreover, since the control sub-pixels in the light valve controller are in one-to-one correspondence with the display sub-pixels in the liquid crystal cell, the display device according to the embodiment of the present disclosure can adjust the contrast on the scale of the sub-pixels, thereby significantly improving the contrast of the display device.

In some exemplary embodiments, as shown in FIG. 2, the lower substrate 210 is located on a side of the upper substrate 220 facing away from the liquid crystal cell 100; the lower substrate 210 is provided with a first polarizer 2121; one of the upper substrate 220 and the first substrate 110 is provided with a second polarizer 2122; the second substrate 120 is provided with a third polarizer 2123. Optionally, a polarization direction of the third polarizer 2123 is same to a polarization direction of the first polarizer 2121. In this way, the light from the backlight module and incident on the light valve controller can be polarized, and the light emitted from the liquid crystal cell 100 can be observed by the human eye.

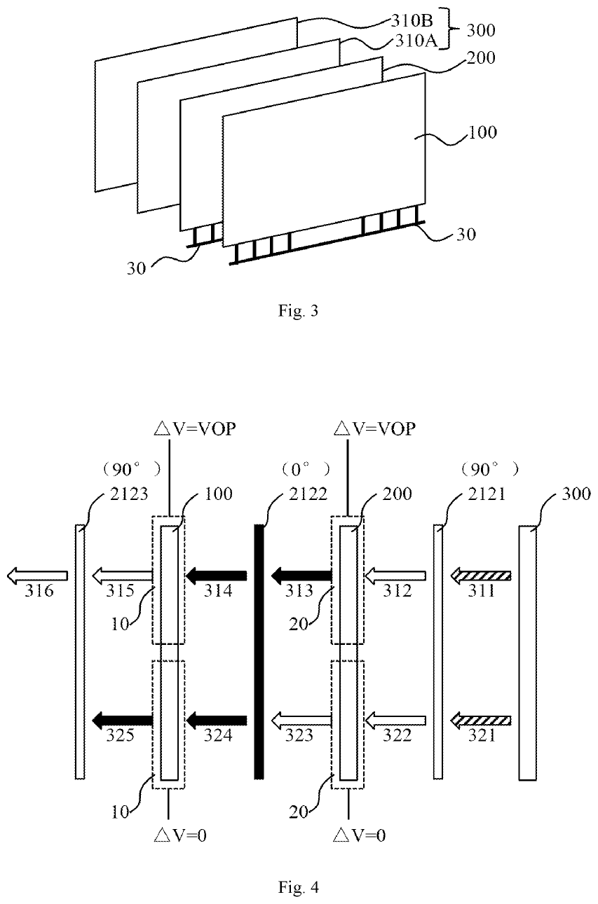

In some exemplary embodiments, as shown in FIG. 3, the display device further includes: a backlight module 300 located at a side of the light valve controller 200 facing away from the liquid crystal cell 100. The backlight module 300 is a light source of the display device, thereby realizing the display function of the display device. In some embodiments, as shown in FIG. 3, the backlight module 300 may further include a plurality of optical films (indicated with the reference signs 310A and 310B). The light valve controller 200 is located on a side of the backlight module 300 on which the optical films 310A and 310B is disposed. Thus, the light valve controller 200 is embedded between the backlight module 300 and the liquid crystal cell 100. In some exemplary embodiments, the light valve controller 200 and the liquid crystal cell 100 are respectively provided with a driver 30 to generate electric fields in the light valve controller and the liquid crystal cell, thereby controlling the rotation of the liquid crystal molecules.

In some exemplary embodiments, as shown in FIG. 2, the display device further includes: a control circuit 400 connected to the first pixel electrodes 111 and the second pixel electrodes 211 respectively. The control circuit 400 is configured to input a same signal to a first pixel electrode 111 and a corresponding second pixel electrode 211. In this way, the contrast of the display device can be significantly improved.

The working principle of the display device will be described in detail below based on specific exemplary embodiments.

In certain exemplary embodiments, referring to FIG. 4, the display device includes three polarizers: the first polarizer 2121 located on a side of the lower substrate facing away from the upper substrate, the second polarizer 2122 located on a side of the array substrate facing away from the color film substrate, and the third polarizer 2123 located on a side of the color film substrate facing away from the array substrate. Those of ordinary skill in the art will understand that the polarization directions of the above three polarizers can be set as long as light can be adjusted by the light valve controller and the liquid crystal cell to realize the display function. For example, three polarizers may have the same polarization direction. In some exemplary embodiments, the polarization direction of the third polarizer 2123 is the same as the polarization direction of the first polarizer 2121, and the polarization direction of the second polarizer 2122 is perpendicular to the polarization directions of the first polarizer 2121 and the third polarizer 2123. According to a specific embodiment of the present disclosure, the transmission axis of the first polarizer 2121 may be in the 90° direction, the transmission axis of the second polarizer 2122 may be in the 0° direction, and the transmission axis of the third polarizer 2123 may be in the 90° direction.

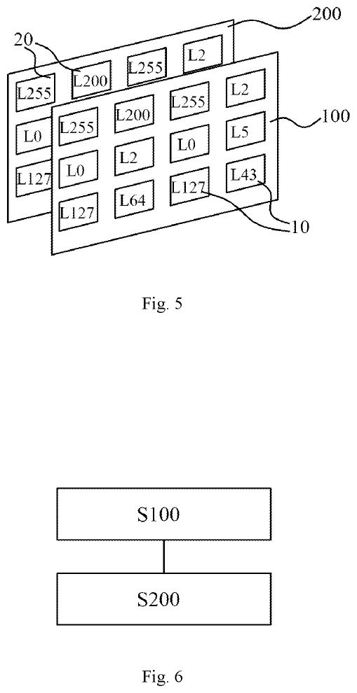

According to an exemplary embodiment, referring to FIG. 4 and FIG. 5, the transmission axis of the first polarizer 2121 is in the 90° direction, the transmission axis of the second polarizer 2122 is in the 0° direction, and the transmission axis of the third polarizer 2123 is in the 90° direction. When the liquid crystal molecules in the light valve controller are deflected by 90°, the brightness of the backlight transmitted by the light valve controller can be a maximum brightness; when the liquid crystal molecules in the light valve controller are deflected by 0°, the brightness of the backlight transmitted by the light valve controller can be a minimum brightness. In the exemplary embodiment shown in FIG. 4, the striped arrow indicates natural light, the white arrow indicates polarized light having a polarization direction of 90°, and the black arrow indicates polarized light having a polarization direction of 0°.

In some exemplary embodiments, during the operation of the display device, at the position where the brightness is the highest in the display image (for example, L255 shown in FIG. 5), a VOP voltage is applied to the control sub-pixel of the light valve controller and the display sub-pixel of the liquid crystal cell. The VOP voltage is a maximum voltage at which the liquid crystal molecules are rotated, such as a voltage at which the liquid crystal molecules are deflected by 90 degrees). As shown in FIG. 4, the natural light 301 emitted by the backlight module 300 passes through the first polarizer 2121 and enters the light valve controller 200, and the natural light 311 is converted to polarized light 311 having a polarization direction consistent with the polarization direction of the first polarizer 2121. For example, the first polarizer 2121 has a transmission axis of 90°, and the natural light 311 transmitted through the first polarizer 2121 is converted to polarized light 312 having a polarization direction of 90°. The liquid crystal molecules in the control sub-pixel 20 are deflected by 90° under the VOP voltage, so that after passing through the liquid crystal molecules to which the VOP voltage is applied, the polarized light 312 having a polarization direction of 90° is deflected into polarized light 313 having a polarization direction of 0°. The transmission axis of the second polarizer 2122 is in the 0° direction, and the transmission axis of the third polarizer 2123 is in the 90° direction. In this way, the polarized light 313 can pass through the second polarizer 2122 and enter the liquid crystal cell 100. The liquid crystal molecules in the display sub-pixel 10 are deflected by 90° under the VOP voltage. The polarized light 314 having a polarization direction of 0° passes through the liquid crystal molecules in the display sub-pixel 10 and is deflected into polarized light 315 having a polarization direction of 90°. The polarization direction of 90° of the polarized light 315 coincides with the polarization direction of the third polarizer 2123. Therefore, the polarized light 315 having a polarization direction of 90° can be observed by the human eye.

In some exemplary embodiments, during the operation of the display device, at the position where the brightness is the smallest in the display image (for example, L0 shown in FIG. 5), no voltage is applied to the control sub-pixels in the light valve controller and the display sub-pixels in the liquid crystal cell. That is, the voltage on the control sub-pixel and the display sub-pixel is zero. As shown in FIG. 4, the natural light 321 emitted from the backlight module 300 passes through the first polarizer 2121 and enters the light valve controller 200, and the natural light 321 is converted to polarized light 322 having a polarization direction consistent with the polarization direction of the first polarizer 2121. For example, the transmission axis of the first polarizer 2121 is 90°, and the natural light 321 is transmitted through the first polarizer 2121 and then converted to polarized light 322 having a polarization direction of 90°. The liquid crystal molecules in the control sub-pixel 20 are not deflected, so that after passing through the liquid crystal molecules in the control sub-pixels, the polarized light 322 having a polarization direction of 90° is still polarized light 323 having a polarization direction of 90°. The transmission axis of the second polarizer 2122 is in the 0° direction, and the transmission axis of the third polarizer 2123 is in the 90° direction. The polarization direction of the polarized light 323 is perpendicular to the transmission axis of the second polarizer 2122. In this way, the polarized light 323 having a polarization direction of 90° is absorbed by the second polarizer 2122, and the residual polarized light 324 is transmitted into the liquid crystal cell 100 through the second polarizer 2122. The liquid crystal molecules in the display sub-pixel 10 are not deflected at a voltage of zero, so that the residual polarized light 324 passes through the liquid crystal molecules in the display sub-pixel 10, and the polarization direction of the residual polarized light 324 is unchanged. Thus polarized light 325 having a polarization direction of 0° is obtained. The polarization direction of the residual polarized light 325 is perpendicular to the polarization direction of the third polarizer 2123. Therefore, the residual polarized light 325 is absorbed by the third polarizer 2123, presenting a darker luminance at a position where the brightness of the display image is a minimum brightness. With the above arrangement, the brightness at the position where the brightness of the display image is minimum can be made darker, so as to significantly reduce the light transmittance at the position where the brightness of the display image is the smallest.

According to an exemplary embodiment, the light valve controller includes a lower substrate, an upper substrate, and liquid crystal molecules; the lower substrate is provided with a polarizer and a second pixel electrode for controlling liquid crystal molecules; the upper substrate is provided with a second common electrode; the control sub-pixels in the light valve controller are arranged in one-to-one correspondence with the display sub-pixels in the liquid crystal cell. By applying the same electric signal to the light valve controller and the liquid crystal cell, the brightnesses of the backlight received at different positions of the liquid crystal cell are different. Therefore, an area corresponding to a portion of the display image with a high brightness can receive a backlight with a high brightness, and an area corresponding to a portion of the display image with a low brightness can receive a backlight with a low brightness. The contrast is adjusted before the backlight enters the liquid crystal cell, thereby obtaining a square of a contrast that can be achieved by using only a single liquid crystal cell. The display effect of the display device having a high contrast according to an exemplary embodiment is shown in FIG. 5. It should be particularly noted that the contrast shown in FIG. 5 (e.g., from L0-L255) is merely exemplary, and it cannot be understood that the contrast of the display device is only 256:1. As described above, the contrast of the liquid crystal display of the ADS display mode in the related art can only reach a level of, for example, 1200. In some exemplary embodiments, the contrast is adjusted in advance by using a light valve controller, so as to achieve a high contrast of, for example, 1200×1200=1440000 (i.e., 1 million).

According to an exemplary embodiment, the light valve controller may not include a color resist layer, a black matrix, or the like. Therefore, the position where the brightness is the largest in the display image has little effect on the transmittance of light. In this way, it is possible to ensure a high transmittance at the position in the display image with a maximum brightness while significantly reducing the light transmittance at the position in the display image with a minimum brightness.

The display mode of the display device is not particularly limited, and those skilled in the art can design the display mode of the display device according to specific conditions. Based on the specific conditions of the display mode, a light valve controller is set in the display device, and the contrast is adjusted in advance by using the light valve controller.

In another aspect of the disclosure, the present disclosure provides a light valve controller. In some exemplary embodiments, the light valve controller is the light valve controller described in the previous exemplary embodiments. Therefore, the light valve controller can significantly improve the contrast of the display device to which the light valve controller is applied and improve the display effect of the display device.

In another exemplary embodiment, a method for manufacturing a display device is provided. In some exemplary embodiments, the display device manufactured by the method may be the display device described above. The display device manufactured by the method may have the same features and advantages as the previously described display device, and details are not described herein again.

In some exemplary embodiments, referring to FIG. 6, the method includes: S100 providing a liquid crystal cell, the liquid crystal cell including a first substrate and a second substrate disposed opposite to each other; and S200 arranging a light valve controller at a side of the first substrate facing away from the second substrate; the light valve controller including an upper substrate and a lower substrate disposed opposite to each other, and liquid crystal molecules located between the upper substrate and the lower substrate. The liquid crystal cell includes a plurality of display sub-pixels arranged in an array; the light valve controller includes a plurality of control sub-pixels arranged in an array; the display sub-pixels and the control sub-pixels are in one-to-one correspondence.

In some exemplary embodiments, in step S100, a liquid crystal cell is provided. The structure of the liquid crystal cell has been described in detail above and will not be described herein. For example, in some exemplary embodiments, the liquid crystal cell includes an array substrate and a color film substrate disposed oppositely, and liquid crystal molecules disposed between the array substrate and the color film substrate. The array substrate is provided with a first pixel electrode for controlling the display sub-pixel, and a polarizer located on a side of the array substrate facing away from the color film substrate. The color film substrate is provided with a second common electrode, a color resist layer, a black matrix, and a polarizer located on a side of the color film substrate facing away from the array substrate. Therefore, the display function of the liquid crystal cell can be realized.

In some exemplary embodiments, in step S200, a light valve controller is provided. In some embodiments, the light valve controller is located on a side of the first substrate (e.g., an array substrate) facing away from the second substrate (e.g., a color film substrate). The structure of the light valve controller has been described in detail above and will not be described herein. For example, in some embodiments, the light valve controller includes a lower substrate and an upper substrate disposed oppositely, and liquid crystal molecules disposed between the lower substrate and the upper substrate. The lower substrate is provided with a second pixel electrode for controlling the control sub-pixel, and a polarizer located on a side of the lower substrate facing away from the upper substrate. The upper substrate is provided with a second common electrode, and a polarizer located on a side of the upper substrate facing away from the lower substrate. According to an exemplary embodiment, the control sub-pixels in the light valve controller are disposed in one-to-one correspondence with the display sub-pixels in the liquid crystal cell. Therefore, before the light enters the liquid crystal cell, the brightness of the backlight incident on the liquid crystal cell is adjusted in advance by using the light valve controller, so that the brightness of the backlight received at different positions of the liquid crystal cell is different. In this way, the area corresponding to a portion of the display image with a high brightness can receive a high brightness, and the area corresponding to a portion of the display image with a low brightness can receive a low brightness, thereby significantly improving the contrast of the display device.

In some exemplary embodiments, the light valve controller can be formed by the following steps: arranging a second common electrode on the upper substrate, and arranging a plurality of second pixel electrodes and a polarizer on the lower substrate; disposing the upper substrate and the lower substrate oppositely, and arranging the liquid crystal molecules between the upper substrate and the lower substrate. An orthographic projection of the first common electrode on the lower substrate overlaps with an orthographic projection of the second common electrode on the lower substrate; an orthographic projection of a first pixel electrode on the lower substrate overlaps with an orthographic projection of a second pixel electrode on the lower substrate. In this way, the control sub-pixels can be arranged in one-to-one correspondence with the display sub-pixels. When the same electric signal is applied to the light valve controller and the liquid crystal cell, the brightness of the backlight received at different positions of the liquid crystal cell is different. Therefore, an area of the liquid crystal cell corresponding to a high brightness of the display image can receive a backlight with a high brightness, and an area of the liquid crystal cell corresponding to a low brightness of the display image can receive a backlight with a low brightness, thereby achieving a display device with a relatively high contrast.

In some exemplary embodiments, after the light valve controller is prepared, the prepared light valve controller is coupled to the liquid crystal cell. The manner of coupling the light valve controller to the liquid crystal cell is not particularly limited and can be designed by those of ordinary skill in the art according to specific conditions.

In some exemplary embodiments, the method may further include providing a backlight module and coupling the backlight module to the light valve controller. The backlight module is located on a side of the light valve controller facing away from the liquid crystal cell. The manner of coupling the backlight module to the light valve controller is also not particularly limited and can be designed by those of ordinary skill in the art according to specific conditions.

In some exemplary embodiments, the method may further include providing a control circuit connected to the second pixel electrodes and the first pixel electrodes. The control circuit may apply the same electric signal to the second pixel electrodes and the first pixel electrodes. In this way, a display device having a high contrast can be achieved.

In summary, the light valve controller can be prepared by a simple production process. The light valve controller can be coupled to the liquid crystal cell to obtain a display device with a high contrast, and such a light valve controller may not include a color resist layer, a black matrix, or the like, thereby further simplifying the production process.

In another exemplary embodiment, the present disclosure proposes a method of controlling contrast of a display device. The display device may be the display device described above. Therefore, the display device may have the same features and advantages as the previously described display device, which will not be described herein again. According to an exemplary embodiment, the method includes: controlling a display sub-pixel and a corresponding control sub-pixel by applying a same gray scale. For example, it is possible to adjust the liquid crystal molecules in the display sub-pixel and the liquid crystal molecules in the corresponding control sub-pixel to have the same deflection degree, thereby presenting the same gray scale. In this way, the contrast of the display device can be significantly improved by a simple method.

In some exemplary embodiments, adjusting the liquid crystal molecules in the display sub-pixel and the liquid crystal molecules in the corresponding control sub-pixel to have the same deflection degree can be achieved by the following steps: applying a same common voltage signal on the first common electrode and the second common electrode; and inputting a same signal to a first pixel electrode and a corresponding second pixel electrode by a control circuit. In this way, the liquid crystal molecules in the display sub-pixel and the liquid crystal molecules in the corresponding control sub-pixel can be adjusted to have the same deflection degree by a simple method. Before the light enters the liquid crystal cell, the amount of light from the backlight and incident on the liquid crystal cell is adjusted in advance by using the light valve controller, so that the brightness of the backlight received at different positions of the liquid crystal cell is different. In this way, the area corresponding to a portion of the display image with a high brightness can receive a high brightness, and the area corresponding to a portion of the display image with a low brightness can receive a low brightness, thereby significantly improving the contrast of the display device.

In the description of the present disclosure, the orientation or positional relationship of the terms “upper”, “lower” and the like is based on the orientation or positional relationship shown in the drawings, and is merely for the convenience of describing the present disclosure and does not require that the disclosure must be constructed and operated in a specific orientation, therefore, it should not be construed as limiting the disclosure.

In the description of the present specification, the description of the terms “an embodiment”, “another embodiment” or the like means that the specific features, structures, materials or characteristics described in connection with the embodiments are included in at least one embodiment of the present disclosure. In the present specification, the schematic representation of the above terms is not necessarily directed to the same embodiment or example. Furthermore, the particular features, structures, materials, or characteristics may be combined in a suitable manner in any one or more embodiments or examples. In addition, combinations of different embodiments or examples described in the specification and features of the various embodiments or examples may be combined by those skilled in the art without contradicting each other. Further, it should be noted that in the present specification, the terms “first” and “second” are used for descriptive purposes only and are not to be construed as indicating or implying a relative importance or implicitly indicating the number of the technical features indicated.

The above exemplary embodiments are only used for explanations rather than limitations to the present disclosure, the person of ordinary skill in the related technical field, in the case of not departing from the spirit and scope of the present disclosure, may also make various modifications and variations, therefore, all the equivalent solutions also belong to the scope of the present disclosure, the patent protection scope of the present disclosure should be defined by the claims.

1. A display device, comprising:
a liquid crystal cell comprising a first substrate and a second substrate disposed opposite to each other; and
a light valve controller located at a side of the first substrate facing away from the second substrate; the light valve controller comprising an upper substrate and a lower substrate disposed opposite to each other, and liquid crystal molecules located between the upper substrate and the lower substrate;
wherein the liquid crystal cell comprises a plurality of display sub-pixels arranged in an array; the light valve controller comprises a plurality of control sub-pixels arranged in an array; the display sub-pixels and the control sub-pixels are in one-to-one correspondence.

2. The display device according to claim 1, wherein the first substrate of the liquid crystal cell is provided with a plurality of first pixel electrodes for controlling the display sub-pixels;
the lower substrate of the light valve controller is provided with a plurality of second pixel electrodes for controlling the control sub-pixels;
an orthographic projection of a first pixel electrode on the lower substrate overlaps with an orthographic projection of a second pixel electrode on the lower substrate.

3. The display device according to claim 2, wherein the second substrate is provided with a first common electrode; the first common electrode is located at a side of the second substrate facing the first substrate;
the upper substrate is provided with a second common electrode; an orthographic projection of the first common electrode on the lower substrate overlaps with an orthographic projection of the second common electrode on the lower substrate.

4. The display device according claim 1, wherein the lower substrate is located on a side of the upper substrate facing away from the liquid crystal cell; the lower substrate is provided with a first polarizer; one of the upper substrate and the first substrate is provided with a second polarizer; the second substrate is provided with a third polarizer.

5. The display device according to claim 4, wherein a polarization direction of the third polarizer is same to a polarization direction of the first polarizer.

6. The display device according to claim 1, further comprising:
a backlight module located at a side of the light valve controller facing away from the liquid crystal cell.

7. The display device according to claim 1, further comprising:
a control circuit connected to the first pixel electrodes and the second pixel electrodes respectively; the control circuit being configured to input a same signal to a first pixel electrode and a corresponding second pixel electrode.

8. A method for manufacturing a display device, comprising:
providing a liquid crystal cell, the liquid crystal cell comprising a first substrate and a second substrate disposed opposite to each other; and
arranging a light valve controller at a side of the first substrate facing away from the second substrate; the light valve controller comprising an upper substrate and a lower substrate disposed opposite to each other, and liquid crystal molecules located between the upper substrate and the lower substrate;
wherein the liquid crystal cell comprises a plurality of display sub-pixels arranged in an array; the light valve controller comprises a plurality of control sub-pixels arranged in an array; the display sub-pixels and the control sub-pixels are in one-to-one correspondence.

9. The method according to claim 8, wherein the second substrate of the liquid crystal cell is provided with a first common electrode, and the first substrate is provided with a plurality of first pixel electrodes;
wherein arranging the light valve controller at the side of the first substrate facing away from the second substrate comprises: arranging a second common electrode on the upper substrate, and arranging a plurality of second pixel electrodes and a polarizer on the lower substrate; disposing the upper substrate and the lower substrate oppositely, and arranging the liquid crystal molecules between the upper substrate and the lower substrate; wherein an orthographic projection of the first common electrode on the lower substrate overlaps with an orthographic projection of the second common electrode on the lower substrate; an orthographic projection of a first pixel electrode on the lower substrate overlaps with an orthographic projection of a second pixel electrode on the lower substrate.

10. A method of controlling a contrast of the display device according to claim 1,
comprising: controlling a display sub-pixel and a corresponding control sub-pixel by applying a same gray scale.

11. The method according to claim 10, wherein the first substrate is provided with a plurality of first pixel electrodes; the lower substrate is provided with a plurality of second pixel electrodes; the second substrate is provided with a first common electrode; the upper substrate is provided with a second common electrode;
wherein the method further comprises:
applying a same common voltage signal on the first common electrode and the second common electrode; and
inputting a same signal to a first pixel electrode and a corresponding second pixel electrode by a control circuit.

12. The display device according to claim 2, wherein the lower substrate is located on a side of the upper substrate facing away from the liquid crystal cell; the lower substrate is provided with a first polarizer; one of the upper substrate and the first substrate is provided with a second polarizer; the second substrate is provided with a third polarizer.

13. The display device according to claim 3, wherein the lower substrate is located on a side of the upper substrate facing away from the liquid crystal cell; the lower substrate is provided with a first polarizer; one of the upper substrate and the first substrate is provided with a second polarizer; the second substrate is provided with a third polarizer.
